(19) United States
(12) Patent Application Publication
(10) Pub. No.: US 2026/0125095 A1
(43) Pub. Date: May 7, 2026

(54) GEARED BRAKE SYSTEM FOR MANUAL HANDLING EQUIPMENT

(71) Applicant: LOADHOG LIMITED, Sheffield, South Yorkshire (GB)

(72) Inventor: Luke Davis, Sheffield, South Yorkshire (GB)

(21) Appl. No.: 19/118,087

(22) PCT Filed: Sep. 29, 2023
(86) PCT No.: PCT/IB2023/059758

§ 371 Date: Apr. 3, 2025

(30) Foreign Application Priority Data
Oct. 7, 2022 (GB) 2214741.7
Apr. 19, 2023 (GB) 2305746.6

(51) Int. Cl. B62B 5/04; B62B 5/00

(52) U.S. Cl. CPC B62B 5/0485; B62B 5/0093; B62B 5/0433

(57) ABSTRACT

A brake system (200) for manual handling equipment (100), and wheeled manual handling equipment (100). The brake system (200) comprises a foot pedal (108) and a brake mechanism (202) connecting the foot pedal (108) to at least one wheel brake (300). The brake mechanism (202) comprises: a one-way driver (204) to enable push-to-engage and push-to-release actuation of the at least one wheel brake (300) by the foot pedal (108); an output actuator (212, 304) to actuate the wheel brake (300); and a reducer (500) to cause a ratio of output actuator displacement to foot pedal displacement to be greater than 1:1.

### FIELD OF THE INVENTION

Embodiments of the present invention relate to a geared brake system for manual handling equipment. In particular, but not exclusively, they relate to a geared wheeled platform brake system for manual handling equipment such as a wheeled platform.

### BACKGROUND TO THE INVENTION

Manual handling equipment describes a class of material transport equipment onto which goods can be loaded, and which can be moved by hand to transport the goods. An example of material handling equipment is a type of wheeled platform called a dolly. A dolly is a wheeled platform onto which goods can be loaded.

In order to prevent a dolly or the like from rolling away, a brake system is typically included. The brake system may be operated by a foot pedal. To minimise the instantaneous force required to operate the brake system, the foot pedal may have a long pedal travel, such as 60 degrees, to minimise the force required to perform the required amount of mechanical work to operate the brake system.

### BRIEF DESCRIPTION OF VARIOUS EMBODIMENTS OF THE INVENTION

According to various, but not necessarily all, embodiments of the invention there is provided a brake system for manual handling equipment, the brake system comprising a foot pedal and a brake mechanism connecting the foot pedal to at least one wheel brake, wherein the brake mechanism comprises:
a one-way driver to enable push-to-engage and push-to-release actuation of the at least one wheel brake by the foot pedal;
an output actuator to actuate the wheel brake; and
a reducer to cause a ratio of output actuator displacement to foot pedal displacement to be greater than 1:1.

The push-push pedal actuation means that the foot pedal will be depressed regularly via the same repetitive ankle motion. A very long pedal stroke reduces the required instantaneous force through the user's braking foot but can fatigue the user's ankles due to the long pedal stroke. By contrast, a very short pedal stroke increases the required instantaneous force through the foot which can also fatigue the user's ankles. Rather than selecting a pedal stroke length that represents a compromise between foot force and displacement, a reducer has been provided to advantageously ensure that both the pedal stroke length and the required instantaneous force are minimized.

The brake system may be for manual handling equipment. The brake system may be a dolly brake system. The wheel brake may be a friction brake. The friction brake may engage with a contact patch surface of a first dolly wheel. The brake mechanism may further connect the foot pedal to a second wheel brake for a second dolly wheel. The foot pedal may be located along an edge of the dolly, between the first and second dolly wheels.

An advantage is further improved ergonomics because multiple wheels can be braked and released via actuation of a single pedal. In addition, push-push pedal actuation as described earlier means that a lightly-loaded dolly cannot be lifted off the ground by the user's braking foot.

The ratio of the reducer may be a value selected from the range 1.5:1 to 2.5:1. In an example, the ratio is approximately 2:1. This improves ergonomics because the required pedal stroke length is approximately halved without any increase in the required instantaneous force.

A pedal stroke length of the foot pedal required to change a state of the brake system may be a value less than 60 degrees, or may be a value less than 45 degrees, or may be a value of approximately 30 degrees. This improves ergonomics because the pedal stroke length is minimized.

The foot pedal may be pivotable. The output actuator may be rotatable. The ratio of the reducer may control the ratio of output actuator rotation to foot pedal pivoting. The foot pedal may be depressible from a horizontal home position. The pedal stroke length of the foot pedal may be defined as an angular deflection of the foot pedal from the horizontal home position to a position at which a state of the brake system changes (braked/unbraked).

By enabling a minimal pedal stroke length via the reducer, the force from the user's braking foot will be mostly downwards with a minimal forwards force component angled away from the user. A first effect is that the dolly is less likely to roll forwards away from the user while the user is depressing the brake pedal. A second effect is that the force is easier for the user to apply with a foot depression, because the applied force is angled more vertically.

The reducer may connect different shafts to each other. The reducer may cause the different shafts to rotate at different speeds.

The reducer may comprise a gear train. The gear train may comprise an input gear and an output gear. The input gear may have more teeth than the output gear. In another embodiment, the reducer comprises another type of reducer such as a belt drive or lever arrangement.

If the one-way driver is located between the foot pedal and the input gear, the input gear may be toothed around an entire circumference of the input gear, and the output gear may be toothed around an entire circumference of the output gear. Advantageously, this enables the push-push pedal actuation because the gears can rotate in a given direction (dictated by the one-way driver) infinite times.

Alternatively, if the one-way driver is located between the output gear and the output actuator, the gear train will rotate back and forth with each cycle of the foot pedal. Therefore, the input gear may be a sector gear and/or the output gear may be a sector gear.

The input gear and output gear may be arranged along parallel axes. The parallel axes may be non-coaxial. The input gear may be coaxial with an axis of rotation of the foot pedal. The input gear may be coaxial with an axis of rotation of the one-way driver. The output gear may be coaxial with an axis of rotation of an output of the brake mechanism for the at least one wheel brake. The input gear and output gear may be spur gears. The input gear may mesh directly with the output gear. These features of the gear train advantageously improve the compactness of the brake system, particularly with regard to the minimum width of the dolly. The width of the dolly is defined as the length of the edge, of the dolly, at which the foot pedal is located.

The input gear and output gear may be supported by different shafts. A first shaft may support the input gear and at least a portion of the one-way driver. A second shaft may support the output gear and an output actuator of the brake mechanism. The output actuator of the brake mechanism may comprise a cam to operate the at least one wheel brake.

The brake system may comprise a part having the input gear, a ratchet, and an orientation locator for setting an orientation of the part. The orientation locator may be configured to set the orientation of the part such that a dead zone of initial foot pedal travel is provided.

The brake mechanism may further connect the foot pedal to a second wheel brake. The brake mechanism may comprise a plurality of the reducers. The plurality of reducers may comprise a first reducer located to a first side of the foot pedal, and a second reducer located to a second, opposite side of the foot pedal. If each reducer comprises a gear train, the plurality of gear trains may therefore comprise a first gear train located to the first side of the foot pedal, and a second gear train located to the second, opposite side of the foot pedal. An advantage of this arrangement is that the forces are distributed in a symmetrical and balanced manner, reducing the likelihood of the pedal twisting. In addition, the force is spread over a greater surface area, reducing local stress and therefore increasing robustness.

The foot pedal may be mechanically connected to both the first and second reducers. If the reducers are gear trains, the input gears of the first and second gear trains may be coaxial with each other. The input gears of the first and second gear trains may be supported by a same shaft. The same shaft may be the first shaft as described earlier. The output gears of the first and second gear trains may be coaxial with each other. The output gears of the first and second gear trains may be supported by a same shaft. The same shaft may be the second shaft as described earlier. An advantage of this arrangement is that the forces are distributed in a symmetrical and balanced manner, reducing the likelihood of the pedal twisting. In addition, the force is spread over a greater surface area, reducing local stress and therefore increasing robustness.

The one-way driver may be implemented as a one-way rotator. The one-way rotator may comprise a ratchet drive. The ratchet drive may comprise a propelling ratchet meshed to a propelled ratchet. The propelling ratchet may be coupled to the foot pedal and the propelled ratchet may be coupled to the wheel brake via the reducer. If the reducer is a gear train, the ratchet drive may be coaxial with the input gear of the gear train. An advantage of a one-way rotator is that the brake mechanism does not need to be reset after use.

The foot pedal may have a cavity, and the one-way driver may be within the cavity of the foot pedal. Advantages are that the one-way driver is protected from contaminant ingress and collisions from external objects, and that the brake system is more compact.

The reducer may be located outside the cavity of the foot pedal. The reducer may be located outboard of the foot pedal. The reducer may be located outboard of the one-way driver. If the reducer comprises a gear train, the input gear of the gear train may be supported by a same shaft as the propelling ratchet and propelled ratchet, and located outboard (along the shaft) of the propelling ratchet and propelled ratchet.

In this disclosure, an outboard direction refers to a direction towards the at least one wheel brake (corner of the dolly), and an inboard direction refers to a direction towards the foot pedal (centre of an edge of the dolly). With reference to a shaft, an outboard direction refers to a direction towards the ends of the shaft, and an inboard direction refers to a direction towards the centre of the shaft.

When the foot pedal is pushed from a home position, the propelling ratchet may rotate the propelled ratchet to rotate the brake mechanism. When the pushed foot pedal is caused to return to its home position, the meshed propelling and propelled ratchets may slip by one or more tooth positions to enable the foot pedal to return to its home position without back-rotating the brake mechanism.

The ratchet mechanism may include a ratchet spring to urge the propelling ratchet and the propelled ratchet into meshing engagement with each other. The ratchet spring may urge the propelled ratchet into engagement with the propelling ratchet. The ratchet spring may be within the cavity of the foot pedal. The ratchet spring may apply an urging force coaxial with an axis of rotation of the braking mechanism and the foot pedal.

A part of the one-way driver may be an integrally moulded portion of the foot pedal. For example, if the one-way driver comprises a one-way rotator, a part of the one-way rotator may be the integrally moulded portion referred to. If the one-way driver comprises a ratchet drive, the propelling ratchet of the ratchet drive may be the integrally moulded portion referred to. The integrally moulded portion may be a portion of the left or right boundary surface portion of the foot pedal.

Each of the left and right boundary surface portions of the foot pedal may further be supported by a pedal bearing about which the foot pedal can rotate. Each pedal bearing may be an integrally moulded portion of the respective left or right boundary surface portion. The reducer may be located outboard of the pedal bearing. If the reducer comprises a gear train, the input gear may be located outboard of the pedal bearing.

If the foot pedal is connected to two wheel brakes for separate wheels, one to each side of the foot pedal, then the brake mechanism may comprise an additional, second one-way driver. The second one-way driver may be the same type of driver as the first one-way driver.

Both one-way drivers may be within the cavity of the foot pedal. Part of the first one-way driver may be an integrally moulded portion of a left boundary surface portion of the foot pedal, and part of the second one-way driver may be an integrally moulded portion of a right boundary surface portion of the foot pedal.

An advantage of two one-way drivers, such as two ratchet drives, is that force is distributed from the foot pedal to both wheel brakes in a symmetrical and balanced manner, reducing the likelihood of the pedal twisting. In addition, the force is spread over a greater surface area, reducing local stress and therefore increasing robustness.

If two one-way drivers are provided, then two reducers may likewise be provided. The first and second reducers may be outboard of the first and second one-way drivers. If the reducers comprise gear trains, the input gears of the first and second gear trains may be coaxial with the first and second one-way drivers. The input gears of the first and second gear trains may be supported by a same shaft as the first and second one-way drivers. The same shaft may be the first shaft referred to earlier. The first and second gear trains and first and second one-way drivers may be symmetrically arranged with respect to the foot pedal.

The at least one wheel brake can comprise a first wheel brake. The brake mechanism may comprise a cam operable on the first wheel brake, the first wheel brake being movable between a braking position and a non-braking position. The cam can comprise a plurality of lobes. The nose of each lobe of the cam can be a flat nose so that the braking position is stable.

The cam may be coupled to the one-way driver via the reducer. Therefore, rotating the foot pedal by a first angle causes the cam to rotate by a second, greater angle.

The cam may be rotatable in a drive direction to move the first wheel brake to the braking position. The cam may be further rotatable in the drive direction to enable the first wheel brake to move (e.g., bias back) to the non-braking position.

The foot pedal may be movable in drive and return directions. The drive direction of the foot pedal may be a downwards pushing direction of the foot pedal. Alternatively, the drive direction may be an upwards pushing direction of the foot pedal. The one-way driver may rotate the cam when the foot pedal is moved in the drive direction. The one-way driver may rotate the cam each time the foot pedal is moved in the drive direction. The one-way driver may rotate the cam each time the foot pedal is moved in the drive direction to alternately move the wheel brake between the braking position and the non-braking position.

The brake mechanism may include a cam follower to transmit a force applied by the cam to the wheel brake to move the wheel brake to the braking position.

The first shaft may be rotatable by the one-way driver when the one-way driver is rotated by movement of the foot pedal in the drive direction.

The first shaft may extend through the cavity of the foot pedal. The first shaft may extend through the left boundary surface portion of the foot pedal and through the right boundary surface portion of the foot pedal. The second shaft may extend outside the cavity of the foot pedal. The second shaft may be only connected to the foot pedal via the or each reducer.

The first shaft may be supported by the or each pedal bearing about which the foot pedal can rotate.

The first shaft may be connected to the second shaft by the or each reducer. The same second shaft may interconnect the wheel brakes of first and second wheels, if the foot pedal can brake multiple wheels simultaneously. The second shaft may be a single shaft extending continuously from the actuator (e.g., cam) of one of the wheel brakes to that of the other of the wheel brakes. The or each distal end of the second shaft, distal from the foot pedal, may be supported by a cam bearing about which the cam can rotate.

The advantages of a continuous second shaft through the whole subassembly are improved structural integrity, convenient assembly, and ensuring the wheel brakes stay synchronized.

If the one-way driver comprises a ratchet drive, the first shaft may extend through the ratchet drive. The first shaft may be rotatable in the drive direction by rotation of the propelled ratchet. The propelled ratchet may be supported by the first shaft at a fixed orientation so that rotation of the propelling ratchet rotates the first shaft to cause rotation of the cam to move the wheel brake between the braking position and the non-braking position.

The propelled ratchet may be slidable along the shaft away from the propelling ratchet, to enable the ratchet drive to slip by one or more tooth positions. The propelled ratchet may be slidable away from the propelling ratchet against a bias force. The bias force may be from the ratchet spring.

The ratchet spring may be coiled around the first shaft. The ratchet spring may be connected directly or indirectly to the first shaft, and to the propelled ratchet. A ratchet carrier may be provided on the first shaft to provide a reaction force to the ratchet spring so that the propelled ratchet is biased towards the propelling ratchet. The ratchet carrier may be fixedly mounted on the first shaft. The ratchet carrier may be located inside the cavity of the foot pedal.

The ratchet carrier may further comprise a propelled ratchet guide socket into which a portion of the propelled ratchet is slidable, when the propelled ratchet slides away from the propelling ratchet. This secures and limits the motion of the propelled ratchet.

If two ratchet drives are provided, the ratchet carrier may be centrally located between the two ratchet drives. The ratchet carrier may be double-sided, to connect to a corresponding second ratchet spring and second propelled ratchet of the second ratchet drive.

The brake system may further comprise a pedal return spring to urge the foot pedal towards its home position. The pedal return spring may be within the cavity of the foot pedal. The pedal return spring may be wound around the ratchet carrier, between a pair of flanges on the ratchet carrier. The pedal return spring may be sized to overcome force from the ratchet spring, so that the ratchet spring can resiliently deform to enable the propelled ratchet to slip relative to the propelling ratchet by one or more tooth positions.

According to various, but not necessarily all, embodiments of the invention there is provided wheeled manual handling equipment comprising a body, a plurality of wheels, and a brake system as described above operable on the wheels. The wheeled manual handling equipment may comprise a wheeled platform. The wheeled manual handling equipment may comprise a dolly. The wheeled manual handling equipment may comprise the at least one wheel brake.

The body of the wheeled manual handling equipment may comprise a first housing portion for the reducer. The first housing portion may be an integrally-moulded portion of the body. A second housing portion may be securable to the first housing portion to enclose the reducer.

### BRIEF DESCRIPTION OF THE DRAWINGS

For a better understanding of various examples of embodiments of the present invention reference will now be made by way of example only to the accompanying drawings in which:

FIG. 1 illustrates an example of a wheeled manual handling equipment;

FIG. 2A illustrates an example ungeared brake system in a non-braking condition;

FIG. 2B illustrates the ungeared brake system in a braking condition;

FIG. 3 illustrates a detail view of a wheel brake;

FIG. 4 illustrates an example foot pedal subassembly;

FIG. 5 illustrates an example foot pedal;

FIG. 6 illustrates a ratchet carrier to which a pair of one-way drivers are connected;

FIG. 7A illustrates the pair of one-way drivers, with the ratchet carrier omitted to reveal internal ratchet springs;

FIG. 7B illustrates the ratchet carrier with the one-way drivers omitted to reveal ratchet guide sockets;

FIG. 8 illustrates an example geared brake system from a first perspective;

FIG. 9 illustrates the geared brake system from a second perspective;

FIG. 10 illustrates how each gear train can be housed;

FIG. 11 illustrates an example geared brake system; and

FIGS. 12A-12B illustrate an example locator for assembling the geared brake system.

### DETAILED DESCRIPTION OF VARIOUS EMBODIMENTS OF THE INVENTION

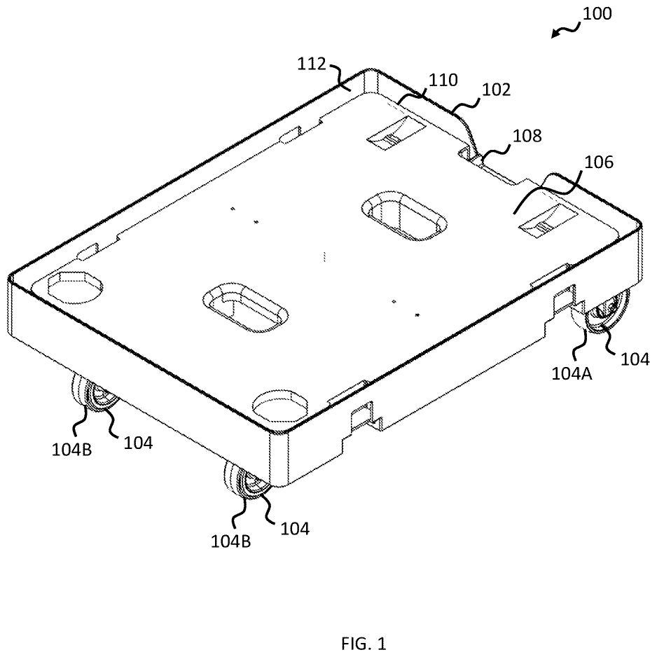

FIG. 1 illustrates a general arrangement of wheeled manual handling equipment 100. The illustrated wheeled manual handling equipment 100 is a dolly. However, in other implementations, the wheeled manual handling equipment 100 could be a different type of manual handling equipment.

The dolly 100 comprises a body 102 and a plurality of wheels 104 beneath the body 102. The body 102 in FIG. 1 is a wheeled platform 106 for supporting a load. The platform 106 may be substantially flat and may comprise upstanding flanges 112 at its edges to prevent load spillage. The height of the platform 106 above ground level (bottom of wheels 104) may be less than 30 centimetres.

The wheels 104 may be casters. A wheel may be provided under each corner of the wheeled platform 106. The wheels 104 are arranged in two pairs: a first pair of wheels 104A at one end of the body 102, and a second pair of wheels 104B at the opposite end of the body 102.

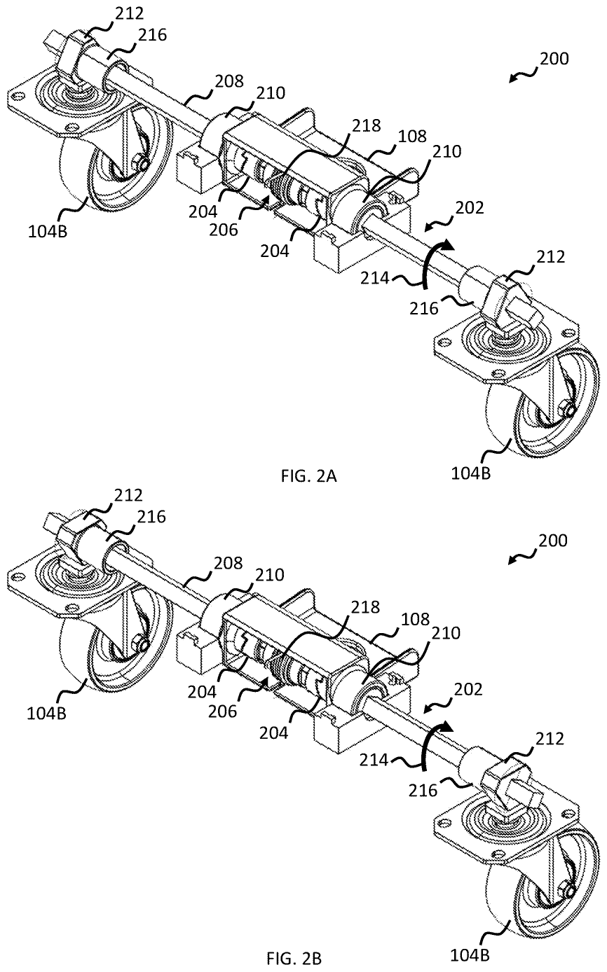

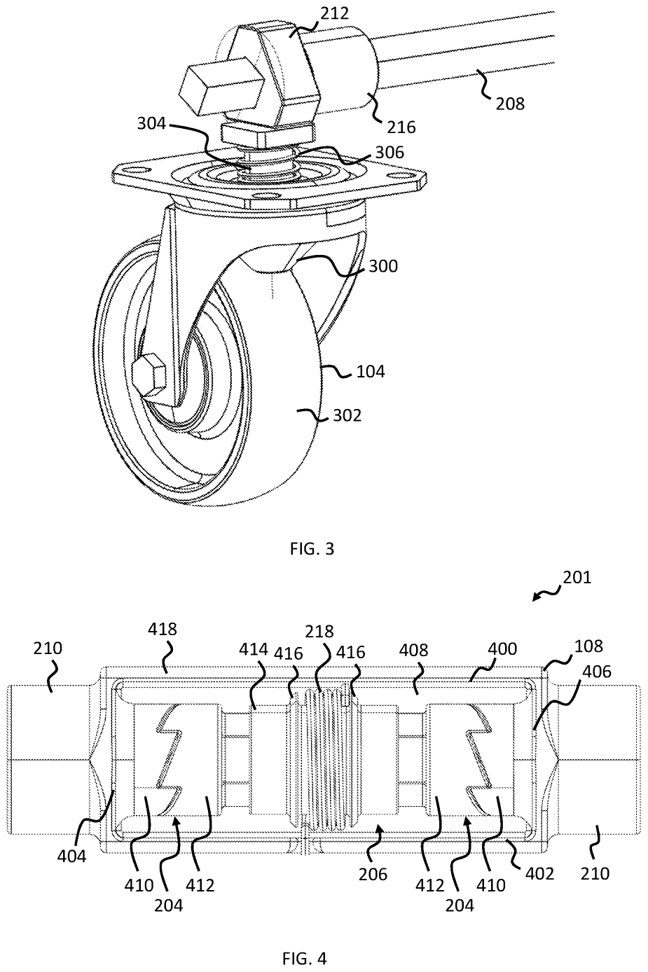

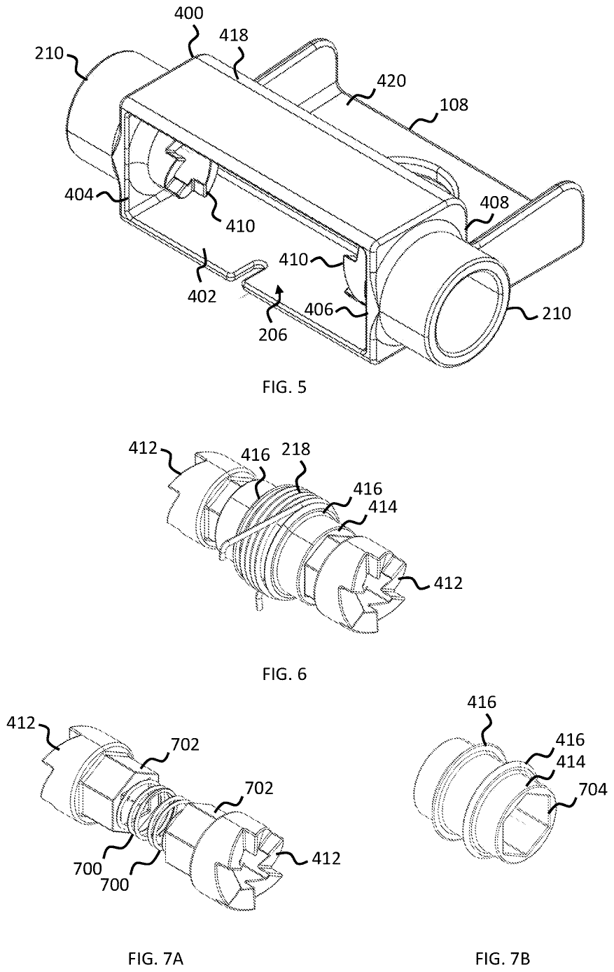

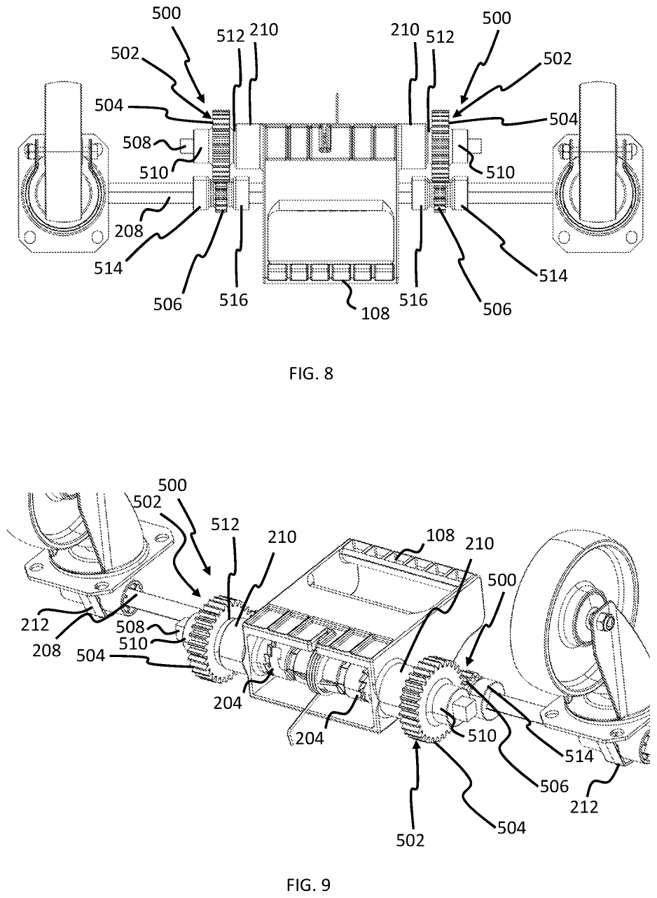

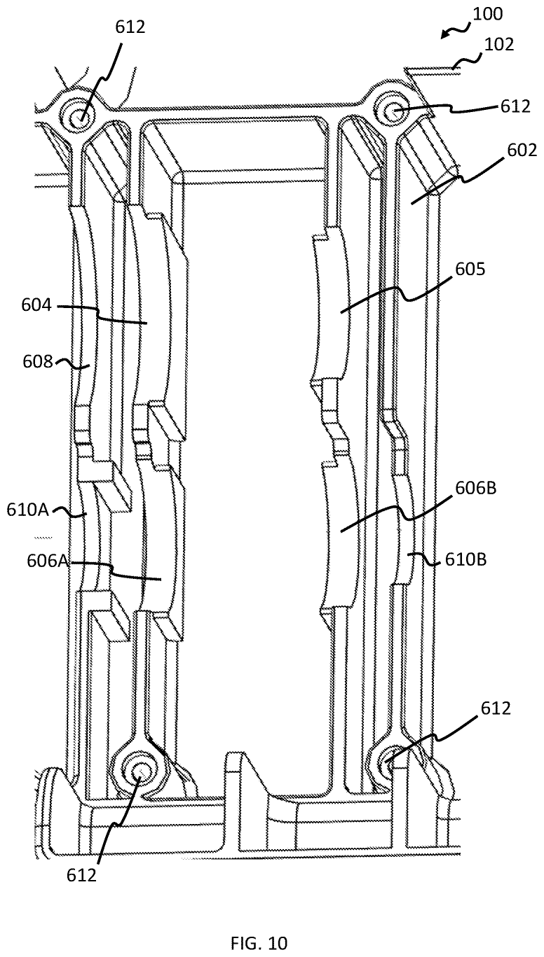

The first pair of wheels 104A are connected to a brake system 200 as illustrated in the later FIGS. FIGS. 8-9 show a geared brake system 200 embodying the reducers 500 described herein. For contrast, FIGS. 2A-2B shows an ungeared brake system 200 that does not comprise the reducers 500. FIGS. 3-7B are generic to both versions of the brake system 200.

The second pair of wheels 104B are not connected to a brake system 200. In another implementation, only a single wheel is connected to a brake system 200, or both pairs of wheels 104A, 104B are connected to a or a respective brake system 200.

In some, but not necessarily all examples, the first pair of wheels 104A may be non-steerable wheels. The second pair of wheels 104B may be steerable wheels.

FIG. 1 illustrates a foot pedal 108 for the brake system 200 of FIGS. 8-9. The foot pedal 108 is located along an edge 110 of the dolly 100, between the wheels of the first pair of wheels 104A. The foot pedal 108 is located at a gap in the upstanding flange 112 of the edge 110.

The illustrated foot pedal 108 can be pushed in a downwards, drive direction from its illustrated home position to change the state of the brake system 200. The brake system 200 enables push-to-engage and push-to-release actuation by the foot pedal 108. The foot pedal 108 may automatically move in a return direction to its home position when the foot pedal 108 is no longer depressed.

FIGS. 2A and 2B illustrate an example ungeared brake system 200 in a non-braking condition and a braking condition, respectively. The ungeared brake system 200 is operable on the first pair of wheels 104A.

The ungeared brake system 200 includes the foot pedal 108, and a brake mechanism 202 connecting the foot pedal 108 to wheel brakes 300 (FIG. 3) so that both wheels 104A can be braked simultaneously by a single depression of the foot pedal 108. In FIGS. 2A-2B, each wheel brake 300 is concealed by wheel caster castings in FIGS. 2A-2B, but an example can be seen in the detail view of FIG. 3. FIG. 3 illustrates a wheel brake 300 comprising a friction brake which can be moved by the ungeared brake system 200 to frictionally engage with the outer surface (contact patch surface 302) of the wheel 104.

Returning to FIGS. 2A-2B, the foot pedal 108 is again shown in its default, home position. The foot pedal 108 is optionally rotatable about an axis of rotation, when depressed. The foot pedal 108 is therefore supported on pedal bearings 210, coaxial with said axis, about which the foot pedal 108 can rotate. A pedal bearing 210 is located to each of the left and right side of the foot pedal 108. The pedal bearings 210 may be sufficiently strong and proximal to the sides of the pedal to react against the weight of a human.

In order to enable push-to-engage and push-to-release operation, FIGS. 2A-2B illustrate a pair of one-way drivers 204. Their operation is described in detail later with reference to FIGS. 4-7B. The one-way drivers 204 are housed within a cavity 206 of the foot pedal 108, one to the left side of the cavity 206 and one to the right side of the cavity 206. The cavity 206 is described in detail later, with reference to FIG. 4.

The input of the brake mechanism 202 comprises the foot pedal 108, and the output actuator of the brake mechanism 202 comprises a cam arrangement for each wheel brake 300. The cam arrangement includes a cam 212 and a cam follower 304.

The cam 212 may either be single-lobed or multi-lobed, depending on the implementation. The illustrated cam 212 is multi-lobed. The detail view of FIG. 3 illustrates the cam 212 as comprising three lobes, each operable on the wheel brake 300 to move the wheel brake 300 to a braking position. The lobes are interconnected by base surfaces.

The illustrated cam 212 is a faceted cam to define stable positions of the wheel brake 300. The faceted cam can have flat noses. However, a curved cam could be used instead. The illustrated cam 212 is a truncated polygonal cam, with truncated corners of the cam defining lobes. As shown, the cam 212 may optionally be a truncated triangular shape.

The cam follower 304 of FIG. 3 comprises an elongate stem having a cam-engaging head at one end, and the wheel brake 300 connected at its other end. A brake return spring 306 is located between the cam-engaging head and a substrate (e.g., wheel caster casting plate), to bias the cam-engaging head against the cam 212.

In a braking condition of the brake system 200, the wheel brakes 300 are in a braking position frictionally engaged with the wheel. In a non-braking condition of the brake system 200, the wheel brakes 300 are in a non-braking position as shown in FIG. 3, at which the wheel brake 300 is not engaged with the wheel.

As shown in FIGS. 2A-2B, the cams 212 are rotatable in a drive direction 214 of rotation to move the wheel brakes 300 to the braking position. The drive direction 214 of rotation may be the same direction of rotation as the foot pedal 108.

Since the foot pedal 108 is push-to-engage and push-to-release, the drive direction 214 may be the only direction in which the cams 212 can rotate. The one-way drivers 204 may prevent rotation of the cams 212 in the opposite direction than the drive direction 214.

A first rotation of the cam 212 in the drive direction 214 engages its lobe with the cam follower 304 to move the wheel brake 300 to the braking position. A second, consecutive rotation of the cam 212 in the drive direction 214 engages its base surface with the cam follower 304 to enable the brake return spring 306 (FIG. 3) to return the wheel brake 300 to the non-braking position. Further rotation of the cam 212 in the drive direction 214 will engage further lobe(s) (if any) and base surface(s) (if any) in alternating fashion, until the cam 212 has completed a full rotation.

Each base surface of each cam 212 is angularly separated from the next lobe of the cam 212 by an angular of 60 degrees. Therefore, the cams 212 need to be rotated by 60 degrees to transition them to the next state. In the ungeared implementation of FIGS. 2A-2B, the ratio between foot pedal depression and cam rotation is 1:1, so the foot pedal 108 needs to be depressed by 60 degrees to rotate the cam 212 sufficiently. This high required deflection can cause ankle fatigue which is unergonomic. The problem of how to make the brake system 200 more ergonomic is solved by the reducers 500 shown in FIGS. 8-9 and described later.

Each above-described rotation of the cams 212 is driven by a single depression of the foot pedal 108 in the drive direction 214. The one-way drivers 204 rotate the cams 212 each time the foot pedal 108 is moved in the drive direction 214. When the foot is released from the foot pedal 108, a pedal return spring 218 biases the foot pedal 108 back up to its home position. The one-way drivers 204 decouple the homing motion of the foot pedal 108 from motion of the cams 212, to prevent back-rotation of the cams 212. Therefore, the foot pedal 108 does not need to be continually depressed in order to maintain the current condition of the brake system 200. The foot pedal 108 automatically returns to its home position, from which it can be pushed to engage to wheel brakes 300 and from which it can be pushed again to release the wheel brakes 300.

FIGS. 2A-2B illustrate a shaft 208 interconnecting the cams 212 and extending through the foot pedal 108. The illustrated shaft 208 has a rotationally asymmetric shape (e.g., quadrilateral cross-section) along at least a portion of its length, to provide a rotational coupling to the cams 212 and to the foot pedal 108. In other examples, different coupling means could be provided, and a circular shaft could be used.

The shaft 208 is supported by a plurality of bearings. The shaft 208 is supported in its central region by the pedal bearings 210. The ends of the shaft 208 are supported by cam bearings 216 about which the cams 212 can rotate. The illustrated cam bearings 216 are cylindrical sleeves connected to the cams 212, which fit in corresponding sockets of the dolly 100. Therefore, the cams 212 support the ends of the shaft 208 when the shaft 208 is connected to the cams 212.

The shaft 208 extends through the one-way drivers 204. The shaft 208 is rotatable by the one-way drivers 204 when the one-way drivers 204 are rotated in the drive direction 214 by movement of the foot pedal 108 in the drive direction 214. The one-way drivers 204 cannot rotate the shaft 208 in a direction opposite the drive direction 214.

FIG. 4 illustrates the cavity 206 in the foot pedal 108, containing the one-way drivers 204 and the shaft 208. They may be provided as a subassembly 201, during manufacture.

The foot pedal 108 comprises a hollow body 418 containing the cavity 206 therein. The interior surfaces of the cavity 206 comprise an upper boundary surface portion 400, a lower boundary surface portion 402, a left boundary surface portion 404, a right boundary surface portion 406, and a rear (outboard) boundary surface portion 408. The front (inboard) side of the cavity 206 may be open to enable installation and maintenance.

The foot pedal 108 may be composed of one or more moulded parts, which has/have been moulded into a shape comprising the cavity 206. The one-way drivers 204 and the shaft 208 are encapsulated within the cavity 206.

The foot pedal 108 of FIG. 4 further comprises an optional foot platform 420 extending from the outboard side of the hollow body 418, to the rear (outboard) boundary surface portion 408 in an outboard direction. The foot platform 420 acts as a lever and is sized to enable at least a portion of a foot to be placed thereon. The foot platform 420 may be integrally moulded with the hollow body 418 of the foot pedal 108.

As shown in FIG. 4, the pedal bearings 210 can be connected to the foot pedal 108. A first pedal bearing 210 is connected to the left side of the foot pedal 108 and the second pedal bearing 210 is connected to the right side of the foot pedal 108. As shown, the first pedal bearing 210 may be connected to the exterior side of the left boundary surface portion 404, and the second pedal bearing 210 may be connected to the exterior side of the right boundary surface portion 406.

The pedal bearings 210 may be integrally moulded portions of the foot pedal 108. The pedal bearings 210 may be integrally moulded portions of the hollow body 418.

As shown in FIG. 4, each one-way driver 204 comprises a one-way rotator in the form of a ratchet drive. Each ratchet drive 204 comprises a propelling ratchet 410 meshed to a propelled ratchet 412.

In the ungeared version of FIGS. 2A-2B, the shaft 208 supports the propelled ratchets 412 and is rotated by rotation of the propelled ratchets 412.

In the geared version of FIGS. 8-9, two shafts are provided. A first shaft 508 supports the propelled ratchets 412 and is rotated by rotation of the propelled ratchets 412. The first shaft 508 drives the reducers 500 (FIGS. 8-9) which drive the (second) shaft 208. The second shaft 208 is parallel to the first shaft 508. The second shaft 208 is longer than the first shaft 508, by connecting to both cams 212. The reducers 500 rotate the second shaft 208 by double the angle of the first shaft 508. The output shaft: input shaft ratio is therefore 2:1.

Referring to the geared version of FIGS. 8-9, depression of the foot pedal 108 rotates each propelling ratchet 410 in the drive direction 214, causing each propelling ratchet 410 to rotate its corresponding propelled ratchet 412 in the drive direction 214, causing the propelled ratchets 412 to rotate the first shaft 508 in the drive direction 214, causing the reducers 500 to rotate the second shaft 208, causing the second shaft 208 to rotate the cams 212 in the drive direction 214, causing the cams 212 to change the state of the wheel brakes 300.

In other embodiments, a different type of one-way driver could be implemented such as a clutch.

Each ratchet drive 204 is located within the cavity 206 of the foot pedal 108, as shown in the FIGs. Two ratchet drives 204 are shown, at symmetrically opposite sides of a centre of the foot pedal 108. This ensures that force from the foot pedal 108 is applied symmetrically. However, alternative implementations could rely upon a single ratchet drive or could rely upon more than two ratchet drives.

The propelling ratchet 410 of each ratchet drive 204 is coupled to the foot pedal 108. Therefore, when the foot pedal 108 rotates, the propelling ratchets 410 rotate. FIG. 4 shows that the propelling ratchet 410 of the first ratchet drive 204 can be coupled to the left boundary surface portion of the foot pedal 108, and the propelling ratchet 410 of the second ratchet drive 204 can be coupled to the right boundary surface portion of the foot pedal 108. Each propelling ratchet 410 can be an integrally moulded portion of the foot pedal 108.

Each propelling ratchet 410 can comprise a central opening through which the first shaft 508 of FIGS. 8-9 can extend. The propelling ratchet 410 is not directly connected to the first shaft 508, but is indirectly connected or connectable to the first shaft 508 via the propelled ratchet 412.

By contrast, the propelled ratchet 412 of each ratchet drive 204 is rotatably coupled to the first shaft 508. Therefore, when the propelled ratchet 412 is turned by its corresponding propelling ratchet 410 in the drive direction 214, the propelled ratchet 412 turns the first shaft 508 in the drive direction 214.

The ratchet drives 204 are orientated so that no slippage occurs during turning in the drive direction 214. That is, the meshing force is applied through the steeply sloped ratchet edges of the ratchets, rather than the shallowly sloped ratchet edges of the ratchets.

The meshing plane of each ratchet drive 204, defined as the plane on which the propelling ratchet 410 meshes with the propelled ratchet 412, is perpendicular to the axis of rotation. The two ratchet drives 204 face in symmetrically opposite directions than each other.

When the pushed foot pedal 108 is raised back to its home position by its pedal return spring 218, the meshed propelling and propelled ratchets 412 can slip by one or more tooth positions to enable the foot pedal 108 to return to its home position without back-rotating the first shaft 508 (FIGS. 8-9). That is, the propelling ratchets 410 rotate in the reverse direction, so that the meshing force is now applied through the shallowly sloped ratchet edges of the ratchets, rather than the steeply sloped ratchet edges. A component of the meshing force pushes the propelled ratchets 412 away from the propelling ratchets 410, which is possible because the propelled ratchets 412 can slide away from the propelling ratchets 410, along the first shaft 508. Therefore, the reverse rotation of the propelling ratchets 410 cause the propelled ratchets 412 to slide away from the propelling ratchets 410 and slip by one or more tooth positions, so that the propelled ratchets 412 do not rotate and therefore the first shaft 508, second shaft 208, and cams 212 do not rotate.

The sliding of each propelled ratchet 412 away from the propelling ratchets 410 is resisted by a bias force applied from a ratchet spring 700 as shown in FIG. 7A. The ratchet springs 700 therefore maintain meshing engagement of the propelled ratchets 412 with the propelling ratchets 410, but are not so strong as to prevent slippage by the required number of tooth positions.

The ratchet springs 700 are coiled around the first shaft 508 (FIGS. 8-9), omitted from view in FIG. 7A. The ratchet springs 700 therefore apply their urging forces coaxial with the axis of rotation, to slide the propelled ratchets 412 along the first shaft 508.

The ratchet springs 700 are located within the cavity 206 of the foot pedal 108. FIGS. 6 and 7B illustrate a carrier 414, which is a part inside the cavity 206 of the foot pedal 108 to which various components associated with the one-way drivers 204 are secured. In the illustrated implementation, the carrier 414 is a ratchet carrier. The ratchet carrier 414 is mounted to the first shaft 508 and can rotate with the first shaft 508 and is not slidable along the first shaft 508.

The ratchet carrier 414 comprises seats for the ratchet springs 700. The ratchet carrier 414 comprises a through-hole (socket 704), inside which is provided a ledge (not visible) to act as a spring seat for the ratchet springs 700. The spring seat provides a reaction force to each ratchet spring 700 so that the propelled ratchets 412 are biased towards the propelling ratchets 410.

Each ratchet spring 700 may be connected indirectly to the first shaft 508 via a ratchet carrier 414. The ratchet carrier 414 may be provided on the first shaft 508 to provide a reaction force to each ratchet spring 700 so that the corresponding propelled ratchet 412 is biased towards its propelling ratchet 410. The ratchet carrier 414 may be fixedly mounted on the first shaft 508. The ratchet carrier 414 may be located inside the cavity 206 of the foot pedal 108.

The illustrated ratchet carrier 414 is double-sided because there are two ratchet drives 204 and because the ratchet carrier 414 is centrally located between the two ratchet drives 204. The ratchet carrier 414 could be single-sided if there is only one ratchet drive.

The through-hole of the ratchet carrier 414 may be sized to define a pair of propelled ratchet guide sockets 704 into which a rear portion of each propelled ratchet 412 is slidable. This ensures that the propelled ratchets 412 are constrained to move in only a sliding direction. The illustrated propelled ratchets 412 each comprise a rear plug 702 (the hexagonal protrusions in FIGS. 6, 7A) sized to fit within a ratchet guide socket 704 of the ratchet carrier 414.

If the one-way driver 204 is a different type of driver than a ratchet drive, then the carrier 414 may be a different type of carrier.

A further function of the illustrated ratchet carrier 414 is to provide a channel (defined between flanges 416) for the pedal return spring 218 for automatically returning the foot pedal 108 to its home position. This enables the pedal return spring 218 to be located within the cavity 206 of the foot pedal 108. The pedal return spring 218 is wound around the exterior surface of the ratchet carrier 414, and is retained by the flanges 416 of the ratchet carrier 414. One end of the pedal return spring 218 is connected to a fixed location on the body 102 of the dolly 100, and the other end of the pedal return spring 218 is connected to the foot pedal 108, so that the foot pedal 108 is urged towards its home position.

FIGS. 8-9 illustrate front and rear underside perspective views of the geared version of the brake system 200. The first shaft 508, a pair of the reducers 500, and the second shaft 208, are visible, among other things.

The reducers 500 are in the form of gear trains 502. Each gear train 502 comprises an input gear 504 meshed directly to an output gear 506. The input gears 504 are mounted to the outboard ends of the first shaft 508, outboard of the pedal bearings 210. The output gears 506 are mounted to the second shaft 208 to enable the first shaft 508 to rotate the second shaft 208. The output gears 506 are spur gears that mesh directly with the input gears 504 and therefore rotate in an opposite direction than the input gears 504. Therefore, the shafts 508, 208 rotate in opposite directions. This does not matter because the cams 212 can rotate in either direction.

The output gears 506 are closer to the edge 110 (FIG. 1) of the dolly 100 than the input gears 504. Therefore, the second shaft 208 is closer to the edge 110 of the dolly 100 than the first shaft 508. The second shaft 208 passes above the foot pedal 108 and connects the cams 212 to each other.

The output: input ratio of each gear train 502 is 2:1. The output gears 506 have half the number of teeth as the input gears 504. Therefore, the second shaft 208 rotates at twice the speed/angle of the first shaft 508. Therefore, a 30-degree depression of the foot pedal 108 rotates the cams by the required 60 degrees. It would be appreciated that the reduction ratio and the specific rotation angles may vary dependent upon implementation.

For balance, the first shaft 508 can be supported by bearings 510, 512 located to one or both sides of each input gear 504. The bearing 512 may be in sleeved connection with the pedal bearing 210, so the bearing 512 is only partially visible. The input gear 504 and the bearings 510, 512 may be a single integral part.

For balance, the second shaft 208 can be supported by bearings 514, 516 located to one or both sides of each output gear 506. These bearings 514, 516 are in addition to the cam bearings 216 described earlier. The output gear 506 and the bearings 514, 516 may be a single integral part.

In an alternative embodiment, the one-way drivers 204 are supported by the second shaft 208, and are located between the output gears 506 and the cams 212 instead of being inside the foot pedal cavity. As a consequence, the gear trains 502 will rotate back and forth with each cycle of the foot pedal. Therefore, the input gear 504 may optionally be a sector gear and/or the output gear 506 may optionally be a sector gear, rather than being toothed around their entire circumferences. An advantage is a smaller gear train 502. However, an advantage of the illustrated embodiment of FIGS. 8-9 compared to this alternative embodiment is that in FIGS. 8-9 there is less potential for the ratchets to get out of synchronization.

Referring now to FIG. 10, the underside of the body 102 of the dolly 100 comprises integrally-moulded first housing portions 602, one for each gear train 502. The first housing portion 602 can be formed from a subset of ribs of a plurality of reinforcing ribs of the dolly 100. Each first housing portion 602 forms a base half of a housing, to which a second housing portion (not shown) can be attached, for example via mechanical fixings such as screws. When attached, the corresponding gear train 502 is enclosed. FIG. 10 shows the first housing portion 602 comprising integrally-moulded fixing portions 612 in the form of sockets for the mechanical fixings.

The first housing portion 602 of FIG. 10 further comprises bearing housing portions in the form of half-circle cutouts in the ribs, to support at least some of the above-described bearings. The bearing housing portion 604 supports the pedal bearing 210. The bearing housing portion 605 supports the input gear bearing 510. The bearing housing portions 606A, 606B support the output gear bearings 516, 514 respectively. The second housing portions (not shown) have corresponding bearing housing portions (half-circle cutouts) alignable with those shown in FIG. 10 to support the bearings.

FIG. 10 further illustrates some ribs having openings 608, 610A, 610B to avoid interference with the shafts 508, 208. The openings are aligned with the bearing housing portions. The openings enable the use of deep ribs without interference and without requiring a taller dolly 100. The first shaft 508 extends into the first housing portion 602 via an entrance opening 608 and bearing housing portion 604. The first shaft 508 terminates within the first housing portion 602 so there is no exit opening for the first shaft 508. The second shaft 208 extends all the way through the first housing portion 602 via respective entrance and exit openings 610A, 610B and bearing housing portions 606A, 606B.

During use of the geared brake system 200 shown in FIGS. 3-9, depression of the foot pedal 108 in the drive direction means that the assemblage of the foot pedal 108 and propelling ratchet 410 rotates. The propelling ratchet 410 rotates the propelled ratchet 412. The propelled ratchet 412 rotates the first shaft 508. The first shaft 508 rotates the input gears 504 of both gear trains 502. The input gears 504 rotate the output gears 506. The output gears 506 rotate the second shaft 208. The second shaft 208 rotates the cams 212. The rotation of the cams 212 is synchronised without any differential rotation of the cams 212. If the foot pedal 108 is depressed by the required amount (e.g., 30 degrees), the cams 212 will rotate by the necessary amount (e.g., 60 degrees) and settle into their next detent/stable position which changes the state of the wheel brakes 300.

Although embodiments of the present invention have been described in the preceding paragraphs with reference to various examples, it should be appreciated that modifications to the examples given can be made without departing from the scope of the invention as claimed. For example, the gear trains 502 could be replaced with belt drives or levers.

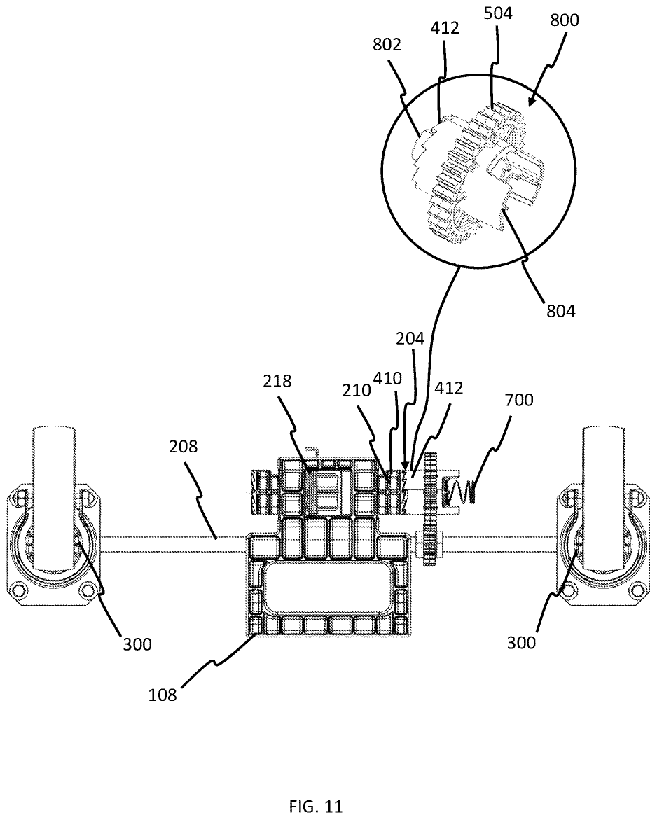

In other embodiments, some parts shown in FIGS. 8-9 may be omitted or merged to reduce part count and/or to reduce the number of different materials. This reduces manufacturing complexity and material usage, and assists with recyclability. FIG. 11 provides a non-limiting example of this.

In FIG. 11, the first shaft 508 of FIGS. 8-9 is omitted. To enable this, the or each propelling ratchet 410 can be relocated to be outside the cavity 206 and facing away from the centre of the foot pedal 108, in the opposite direction to that shown in FIG. 9. The propelled ratchets 412 can be relocated accordingly, to mesh with the propelling ratchets 410.

In the example of FIG. 11, the pedal bearing 210 is modified to comprise a socket (not visible) shaped to receive a part 800. The part 800 comprises the propelled ratchet 412, a rear plug 802 similar to the rear plug 702, and optionally the input gear 504 as the same part. The rear plug 802 fits into the socket in the pedal bearing 210. The part 800 can slide into the socket. A ratchet spring 700 urges the part 800 into the socket, therefore urging the propelled ratchet 412 towards the propelling ratchet 410. The illustrated ratchet spring 700 is outside the foot pedal 108.

The implementation of FIG. 11 makes the first shaft 504 and ratchet carrier 414 redundant so they can be deleted.

The pedal 108 of FIG. 11 may be adapted to include an integral form to support and locate the pedal return spring 218. Alternatively, the pedal return spring 218 may be modified and/or relocated.

FIG. 11 also illustrates an example in which only one one-way driver 204 is provided. The input force on the shaft 208 is therefore asymmetric, which is not an issue if the shaft 208 is rigid.

Turning now to the process of installing the propelled ratchet 412, it would be desirable to accurately set a phase of the propelled ratchet 412 relative to the propelling ratchet 410.

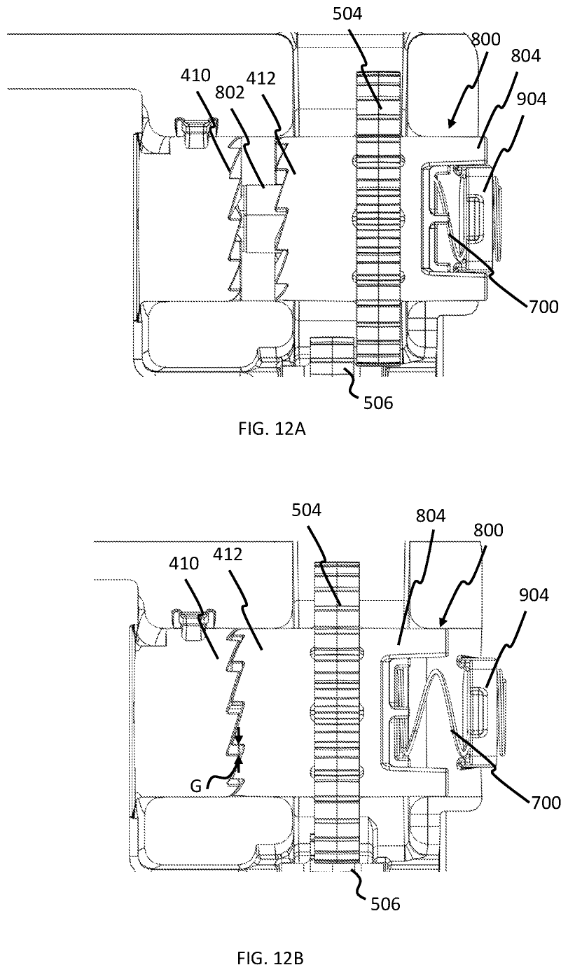

If the gears 504, 506 are initially out of phase by at least one tooth relative to a required alignment, the ratchets 410, 412 would be misaligned, which affects the gap G (FIG. 12B) between the facing steeply sloped ratchet edges. The value of the gap G changes the relationship between pedal travel and brake actuation. FIG. 12B illustrates the desired amount of the gap G, which is only possible if the gears 504, 506 are meshed at the required alignment. The gap G provides a small dead zone of initial foot pedal travel. The dead zone, e.g. 3 to 8 degrees or 5 degrees, provides manufacturing tolerance and also enables the foot pedal 108 to be lowered slightly to allow easier penetration of large boots such as steel toe capped boots, onto the foot pedal 108.

To ensure the required alignment of the gears 504, 506, FIGS. 11 and 12A-12B illustrate an orientation locator 804 secured to a same part 800 as the input gear 504 and propelled ratchet 412. The illustrated orientation locator 804 comprises a non-axisymmetric (non-circle) protrusion shaped to slide against a static part 904 at one orientation or a limited set of orientations, to set the orientation of the part 800.

FIG. 12A shows the part 800 aligned with the propelling ratchet 410 prior to being engaged with the propelling ratchet 412. The ratchet spring 700 is seated at one end to the movable part 800 and at the other end to a spring seat part functioning as the static part 904. The ratchet spring 700 is in a compressed state while the part 800 is held apart from the propelling ratchet 410.

The installer pushes the part 800 towards the static part 904, against an urging force of the ratchet spring 700, until the orientation locator 804 of the part 800 overlaps or slides against the static part 904. This overlap/sliding is possible when the part 800 is at the orientation corresponding to the required alignment of the gears 504, 506. When the installer releases their force, the ratchet spring 700 will slide the part 800 into meshing engagement of the gears 504, 506 and ratchets 410, 412, with the required alignment achieved. This is shown in FIG. 12B.

Features described in the preceding description may be used in combinations other than the combinations explicitly described.

Although functions have been described with reference to certain features, those functions may be performable by other features whether described or not. Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A brake system for manual handling equipment, the brake system comprising a foot pedal and a brake mechanism connecting the foot pedal to at least one wheel brake, wherein the brake mechanism comprises:
a one-way driver to enable push-to-engage and push-to-release actuation of the at least one wheel brake by the foot pedal;
an output actuator to actuate the wheel brake; and
a reducer to cause a ratio of output actuator displacement to foot pedal displacement to be greater than 1:1.

2. The brake system of claim 1, wherein the wheel brake is a friction brake, and wherein the friction brake engages with a contact patch surface of a first dolly wheel.

3. The brake system of claim 1, wherein the ratio of the reducer is a value selected from the range 1.5:1 to 2.5:1.

4. The brake system of claim 1, wherein a pedal stroke length of the foot pedal required to change a state of the brake system is a value less than 45 degrees.

5. The brake system of claim 1, wherein the foot pedal is pivotable, wherein the output actuator is rotatable, and wherein the ratio of the reducer controls a ratio of output actuator rotation to foot pedal pivoting.

6. The brake system of claim 1, wherein the foot pedal is depressible from a horizontal home position.

7. The brake system of claim 1, wherein the reducer comprises a gear train, and wherein the gear train comprises an input gear and an output gear.

8. The brake system of claim 7, wherein the one-way driver is located between the foot pedal and the input gear, wherein the input gear is toothed around an entire circumference of the input gear, and wherein the output gear is toothed around an entire circumference of the output gear.

9. The brake system of claim 7, wherein the input gear and output gear are arranged along parallel axes, wherein the parallel axes are non-coaxial, wherein the input gear is coaxial with an axis of rotation of the foot pedal and/or with an axis of rotation of the one-way driver, and wherein the output gear is coaxial with an axis of rotation of an output of the brake mechanism for the at least one wheel brake.

10. The brake system of claim 7, wherein a shaft supports the output gear and an output actuator of the brake mechanism.

11. The brake system of claim 7, comprising a part having the input gear, a ratchet, and an orientation locator for setting an orientation of the part.

12. The brake system of claim 11, wherein the orientation locator is configured to set the orientation of the part such that a dead zone of initial foot pedal travel is provided.

13. (canceled)

14. The brake system of claim 1, wherein the output actuator of the brake mechanism comprises a cam to operate the at least one wheel brake.

15. (canceled)

16. (canceled)

17. The brake system of claim 1, wherein the one-way driver is implemented as a one-way rotator, wherein the one-way rotator comprises a ratchet drive, and wherein the ratchet drive comprises a propelling ratchet meshed to a propelled ratchet.

18. The brake system of claim 17, wherein the propelling ratchet is coupled to the foot pedal and the propelled ratchet is coupled to the wheel brake via the reducer.

19. The brake system of claim 17, wherein when the foot pedal is pushed from the foot pedal's home position, the propelling ratchet rotates the propelled ratchet to rotate the brake mechanism, and wherein when the foot pedal is caused to return to its home position, the meshed propelling and propelled ratchets slip by one or more tooth positions to enable the foot pedal to return to the foot pedal's home position without back-rotating the brake mechanism.

20. (canceled)

21. The brake system of claim 1, comprising a pedal return spring to urge the foot pedal towards the foot pedal's home position.

22. Wheeled manual handling equipment comprising a body, a plurality of wheels, and the brake system as claimed in claim 1, operable on the wheels.

23. (canceled)

24. The brake system of claim 6, wherein the foot pedal is depressible in a downwards drive direction from the horizontal home position to change the state of the brake system.

25. The brake system of claim 6, wherein the foot pedal is depressible from the horizontal home position to engage the at least one wheel brake and is depressible again from the horizontal home position to release the at least one wheel brake.
